(19) United States
(12) Patent Application Publication
(10) Pub. No.: US 2016/0137467 A1
(43) Pub. Date: May 19, 2016

(54) AUTOMATIC BLACKBOARD RAISING/LOWERING DEVICE

(71) Applicant: Kyu Heung LEE, Chungcheongnam-do (KR)

(72) Inventor: Kyu Heung LEE, Chungcheongnam-do (KR)

(21) Appl. No.: 14/770,461

(22) PCT Filed: Nov. 14, 2013
(86) PCT No.: PCT/KR2013/010342

§ 371 Date: Oct. 5, 2015

(30) Foreign Application Priority Data
Aug. 9, 2013 (KR) 10-2013-0094618

(51) Int. Cl. B66F 3/08; B43L 1/04

(52) U.S. Cl. CPC B66F 3/08; B43L 1/04

(57) ABSTRACT

This invention is for automatic move upward and downward device of full framed board for education blackboard or bulletin board, on which educator write as high as he wants by moving it upward or downward to show it well in the distance.

### TECHNICAL FIELD

This invention is for automatic move upward and downward device of full framed board for education blackboard or bulletin board, on which educator write as high as he wants by moving it upward or downward to show it well in the distance.

### BACKGROUND ART

This inventing removes educator's physical sufferings by controlling board's height automatically without his bending waist or tiptoeing according to educator's height, which makes the students in the back of the classroom comfortable to see board. But, until now it has not been commercialized because production process was complex as well as high power was required in driving part and it was very noisy.

The use of conventional technology of moving upward and downward blackboard was avoided because it was too uncomfortable to make desired height by moving the board plate of center part simply up and down as the weight becomes heavier as blackboard frame is connected to audiovisual devices such as recent multivision and various kinds of secondary blackboard. Conventional patented automatic move upward and downward blackboard was also avoided for the heavy driving noise and not commercialized as its production technology was complex and difficult.

### SUMMARY OF THE INVENTION

### Technical Problems

The purpose of this invention is to solve the problem of conventional technique described in detail by minimizing the cause of induced noise as practically only a little energy is required in full frame of heavy blackboard's moving upward and downward, and to support automatic upward and downward blackboard which is easy to be installed in the field.

The other purpose of this invention is to support automatic move up/downward device which is capable of being easily installed even if surface is uneven, because the wall surface is not plastered with bricks placed or well plastered only on the visible surface.

Also, other purpose of this invention is to support automatic move up/downward blackboard which makes it solve that board is not moved in upward move owing to safety device, but can be accidentally fallen off in downward move due to board's weight when board is inclined by breakdown or obstacles.

### Solution to the Problem

This invention has the features that include multiple link arm (33,34,65), in up/downward blackboard device that can move blackboard frame (78) in up/down direction coupled with the hinge each other; left and right spin screw (35,66) which move at least above one link arm in up/down direction, connected to at least one link arm of above multiple link arms (33,34,65); and motor (40) which drives above right screw axis.

Equipping slider bar up and down (5) on above upper/lower end link arm (33,34), slide device (9,10,11,12) which makes above slider bar up and down (5) possible to move only up/down, support upper/lower end link arm (31,32) linked to upper and lower part of above link arm (33,34), and up/down link fixtures (6,7) fixed on the both end of slider bar up and down (5), and installing above right screw axis (35) on the center of above link arm (33,34), above support upper/lower end link arm (31,32) is composed to move up/downward vertically according to the operation of above right screw axis (35) and above link arm (33,34).

Above link arms (33,34) are composed of four 4-bar link arms, anchor support (1,2,3,4) is installed between above board upper/lower fixtures (6,7), and above support upper end link arm (31) can be linked to blackboard upper end fixing part (6).

Including motor part (40,41,42,43) composed of centerrotate spindle (36) which is one body with above right screw axis (35), motor (40), reducer (41), and motor combined plate (42), above motor combined plate (42) at the end of centerrotate spindle (36) being one body with bushing (37) part by welding, motor part (40,41,42,43) and centerrotate spindle (36) being on a line and cantilever of bushing (37) by establishing motor part (40,41,42,43)'s enough strength, therefore installation gap becoming small between wall surface and blackboard frame (78) and rubber pad (97) being installed in above gap, connecting motor tension spring (45) to motor part (40,41,42,43) and blackboard upper end fixing part (6) can make supplement bad effect due to cantilever constructure by equipping blackboard upper end fixing part (6) with blackboard spring hook (44).

Above tension spring hook (48) being installed on link arm (3,34) and equipping tension spring (49), washer (52) being inserted at both end of link arm (33,34) installation surface by tightening bolt (50) and nut (51), power can be reinforced by making clamping groove for tension spring (49) at 3 places of center, left, and right side and equipping 2˜6 tension springs (49) according to strength of tension spring (49) and weight.

Above link arm (33,34) can be mechanically stabilized by being assembled as wide bottom and narrow top in the longitudinal right/left direction.

Above link arm (65) being composed of two 2-section link arm (65), including upper/lower end support fixture (62,68) linked to link arm (65) with hinge; and slider bar upper end (60) which slides being accepted to lower end support fixture (68), it composes to move up/downward upper support (62) if left and right spin screw (66) is accepted to lower end support fixture (68) and rotated by motor.

Above lower end support fixture (68) being fixed to support fixture operating (8) by bolt, upper support (62) moving up/down by operation of link arm (65) due to motor part (40,41,72) and left and right spin screw (66), board upper/lower link fixture (6,7) fixed at the end of slider bar up and down (5), anchor support (1,2,3,4) installed between board upper/lower link fixture (6,7) and fixed on wall, and upper support (62) linked to blackboard upper end fixing part (6) by bolt and board upper/lower link fixture (6,7) connected to blackboard frame (78), blackboard frame (78) can be moved up/down by motor (40).

Weight support bar (93), weight balance (91), electrode fixed bar (96), access tunnel (95), electrode A (92), and electrode B (94) being equipped on internal upper surface, above blackboard frame (78) can be stopped by electrode A (92) and electrode B (94) contacted due to slide of blackboard frame (78) and relay operating.

Upper/lower compression spring (75,77) equipped to left and right spin screw (66) and slider bar upper end (60), power can be supplemented by compressed spring tension caused by moving upward from the lowest end of internal both ends of upper/lower end support fixture (62,68).

### Effects of the Invention

By this invention, user can handle terminal box safely and easily because of small noise which comes from high efficiency for heavy full blackboard frame, which various functions are assembled and integrated.

Also, for driving parts, like the principle of leverage, strong vertical force, that is, large operating range can be obtained just by small horizontal force, and whole floating weight of blackboard frame according to up/down move is supported to link arm and therefore very small reduced weight is delivered to driving part, that is link arm operating screw, making structure which causes small noise and putting forth stable and great power kinematically.

Also, the unbalance, between the power of descent, assisted by self-gravity of blackboard, and ascent, can be solved as the power of ascent/descent becomes almost equal by assistance of tensility and elasticity of compression spring.

### BRIEF DESCRIPTION OF THE DRAWINGS

FIG. 1. is a configuration view of completely assembled base unit.

FIG. 2. is a front view of 4-bar link device.

FIG. 3. is a side view of 4-bar link device.

FIG. 4. is a tension spring hanger view of 4-bar link.

FIG. 5. is a front view of 2-section scissor device.

FIG. 6. is a side view of 2-section scissor device

FIG. 7. is an up/down view of equipment to unit by 4-bar link.

FIG. 8. is an up/down view of equipment to unit by 2-section link.

FIG. 9. is a rear view of board equipment to 4-bar link.

FIG. 10. is a rear view of board equipment to 2-section link.

FIG. 11. is a configuration view of safety device.

FIG. 12. is a schematic view of automatic control electrical wiring.

FIG. 13. is a shape view of rubber pad.

FIG. 14. is a floor plan view of 4-bar link and 2-section scissor

### BEST MODES FOR CARRYING OUT THE INVENTION

To understand this invention enough, desired practice example of this invention is added for explanation and reference. The example of this invention can be changed to various types, and the range of this invention cannot be translated as limited as following explained example in detail. This example is offered for the person with average knowledge in this field to be explained more completely. Therefore, the shape of elements, etc can be expressed exaggeratedly for the emphasis of clearer explanation. It should be attended that same parts in each figure is expressed as same reference mark. Description for notice function and configuration, which is decided as substance of this invention is clouded unnecessarily, is skipped.

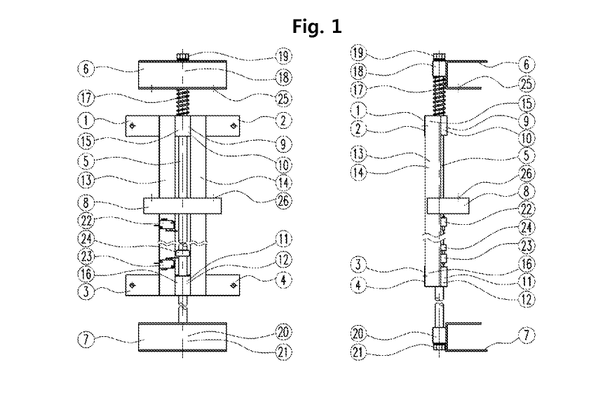

FIG. 1 expresses a front view and a side view of the unit assembled completely as base frame of this invention, all configurations except driving part as base frame are assembled completely, and therefore board ascent/descent device is completed by connection of 4-bar link or 2-section scissor, that is, driving part. as this it becomes two kinds of board ascent/descent device. Completing assembly as unit makes mass production and field installation easy, fast, and comfortable.

For stay (13,14) having no distortion by the force of welding and operation for vertically stable activation of slider bar up and down (5) in unit, left/right stay (13,14) selected as kinetically most stable structure, in which tetragonal pipe is utilized even if torsion and bending moment act in any direction of 360 degree. Left/right side, making one body in parallel, being composed harmoniously, stay upper/lower end fixing part (15,16) being welded as precise height and length above all, left/right stay (13,14) being kept parallel as width of left/right stay (13,14) needs to be equal to thickness of slider bar up and down (9,11), slider bar up and down (5) being kept parallel if slide bar (9,11) being welded, completing welding first by anchor support (1,2,3,4) welding after welding support fixture operating (8) to stay (13,14) vertically in front/rear/left/right side, if anchor support (1,2,3,4) being composed thinly as enough as strength be established and stay (13,14) be kept vertical regardless of wall type during field installation of unit and even though wall surface be curved, anchor support (1,2,3,4), being bent easily and therefore stuck to wall curve, being able to be installed easily, operation being not interfered since strength being established after installation, flection being easily anchor support (1,2,3,4) in stay (13,14) with enough strength.

When inserting slider bar up and down (5) into stay (13,14), bar put in compression spring (17) being inserted in upper part, then stop ring (24) inserted into stay (13,14), and slide bar up and down (5) to rod up/down bracket (18,20) which is welded to board up/down link fixture (6,7) being linked by rod up/down fix bolt (19,21), installation angle should be same with board up/down link fixture (6,7) same direction. Connecting upper/lower end limit switch (22,23) to the front of left stay (13), since precise location would be related to link location of board operation stop ring (24) and installation height from floor, would be easier for location to be established and connected in field installation. It is necessary for bar put in compression spring (17) to make up for driving by spring elasticity.

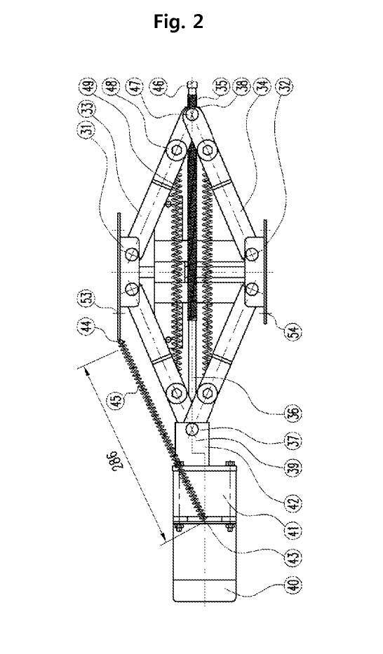

Configurating driving part of ascent/descent function by 4-bar link and 2-section scissor being based on patent-2013-0016809 application, and unit's slide bar up and down (5) being acted only vertically by slide device (9,10,11,12) and supporting link arm (33,34,65) from front/rear/left/right force and becoming smooth and enough for moving blackboard frame (78) in up/down direction with link arm (33,34,65). FIG. 2 is a front view of 4-bar link and this invention is not the method bending like Korean character ‘ [symbol] ’, Same type of two pieces of iron becoming one set of link arm in parallel by hinge point and these four sets of link arm becoming one link arm (33,34), hinge point (47) being linked by six hinges like up/down link arm support (31,32) and bushing (37), link arm (33,34) being composed so that it is reinforced strongly as thick as iron plate by curve, in this case commonly strength for bending moment and torsion according to the operation of much lighter blackboard frame (78) being enough, and uncertainties according not to bending like character ‘ [symbol] ’ would be all solved. Because link arm (33,34) being bent, left/right in length direction is wide and upper part is narrow. Assembling link arm (33,34), kinetically it would be most stable structure and durability also be much better.

Right screw axis exists at horizontal center of link arm (33,34), where nut (38) is inserted. Bushing (37) is inserted in the center of rotation axis which is connected by welding with right screw axis (35). In bushing, not to be moved in left and right direction since centerrotate spindle (36) being separated from bushing (37), move detent (39) is positioned on front and rear of bushing (37), and motor part (40,41,42,43) are at the end of axis of rotation (36). This driving makes link arm (33,34) move smoothly.

It is very important for motor combine plate (42) to be connected centerrotate spindle (35) and bushing (37), especially axis of rotation of 4-bar link arm (33,34) being moved up as high as a half of motor (40)'s height according to ascent of support upper end link arm (31), simultaneously axis of rotation (35,36) and motor (40) moving horizontally, and link arm (33,34) and motor (40) being connected for the overcome of torsion and bending moment according to generation of power. Rotation of 4-bar link is composed of right screw axis (35) and centerrotate spindle (36), which rotate together. If motor part (40,41,42,43) are configurated as connected in one line with centerrotate spindle (36), blackboard frame (78) is installed closely at wall since wall surface, which is installation width of this invention. For compensation of bushing (37) and motor part (40,41,42,43) being unstable connection, which is cantilever, blackboard spring hook (44) being configurated to blackboard upper end fixing part (6) and motor spring hook (43) to motor (40), bad effect of weight of motor being reduced due to cantilever by spring. Tension of motor tension spring (45) considering weight of motor part (40,41,42,43) being kept uniformly, positioning spring hook (43,44) is very important. If proper location is selected in the direction of gear speed reduction (41) at certain distance, the length which keeps uniform motor tension spring (45) tension can be chosen even if location of link arm (33,34) is changed by operation. But, tension should be same in any position by making longer distance of spring (45) in descent status because tension be stronger in ascent status being narrow at position view.

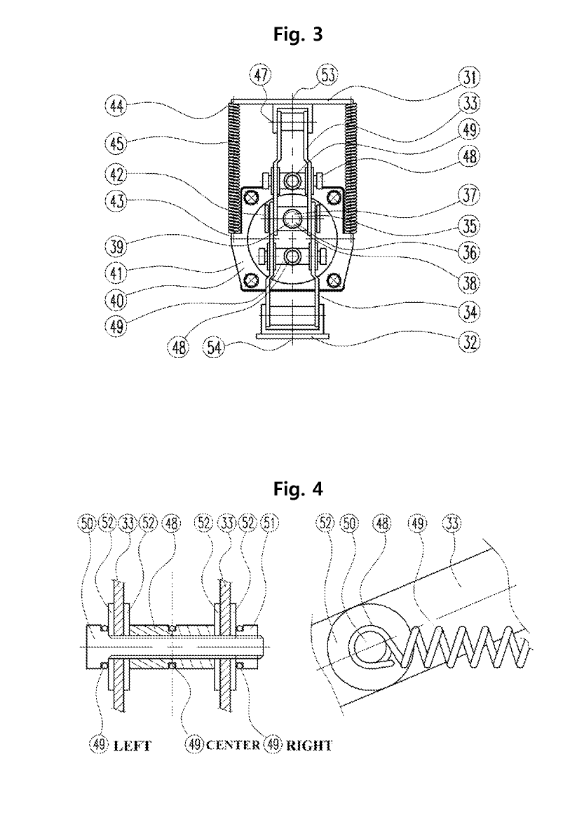

As FIG. 3 expresses a side view of 4-bar link and FIG. 4 is tension spring hook (48) of 4-bar link, tension spring (49) being equipped at upper and lower side of right screw axis (35) as a way of compensation of consumption of heavy power in rather upward move than downward move, power of drive being compensated by its elasticity and tension spring hook (48) being configurated in link arm for equipment of tension spring (49). Not to be loaded heavily to link arm (33,34), washer (52) as same width as link arm is closely inserted. If bolt (50) and nut (51) are tightened, link arm (33,34) is not heavily loaded in link arm (33,34) due to washer (52). Equipping 2˜6 tension spring (49), according to weight of board and spring strength, copes with selected tension strength and board weight actively by making center, right, left, totally 3 grooves of tension spring (49) in tension spring hook (48) and bolt (50).

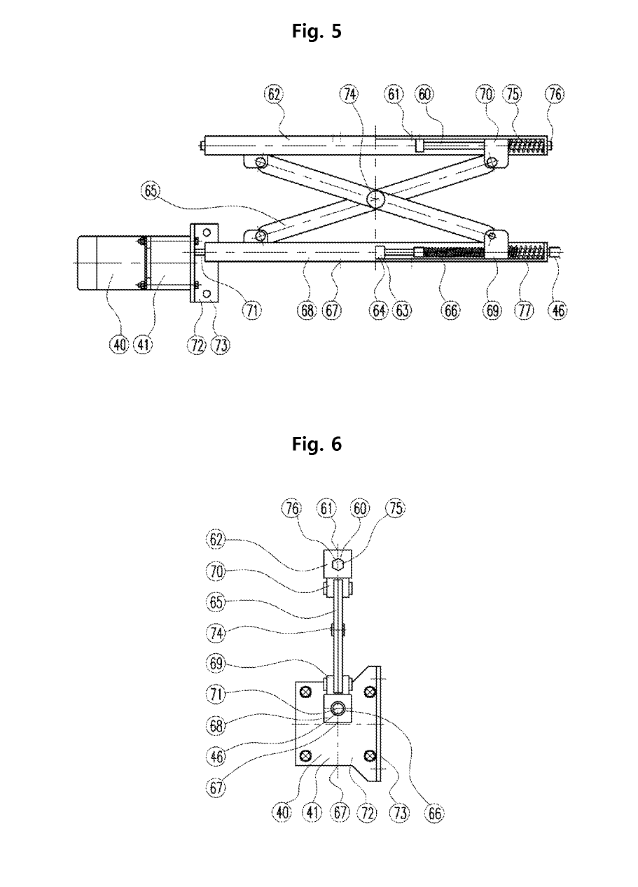

FIG. 5 shows 2-section scissor in a front view, and FIG. 6 is a side view of 2-section scissor. 2-section scissor is made right screw in one side of link arm (65) bottom and left screw in the other side, left and right spin screw (66). According to its rotation, hinge pin (74) of 2-section link arm (65) is interlocked by 5 hinges in left and right spin nut (69) and slider bushing (70). Slider bushing (70) on the upper side of 2-section link arm slides on slider bar upper end (60) and upper support (62) supports it. left and right spin nut (69) on left and right spin screw (66) at the bottom of 2-section link arm (65) supports link arm (65), and lower end support fixture (68) supports spin support housing (63) and bushing (64) at the center. Firstly, of two cores which support power, upper/lower end support fixture (62,68) makes 2-bar x-join arm (65)'s operation smoothly even if slider bushing (70) and left and right spin nut (69) being not processed precisely and clearance of tolerance being a little. Secondly, Compressed tension compensates driving when moving down to up, upper/lower end compression spring (75,77) which is inserted to slider bar upper end (60) and left and right spin screw (66) at the internal both end of upper/lower end support fixture (62,68). Inserting vibration proof pad (73) at the bottom side of motor bracket (72) since 2-section scissor motor (40) being fixed on the wall directly for minimum vibration.

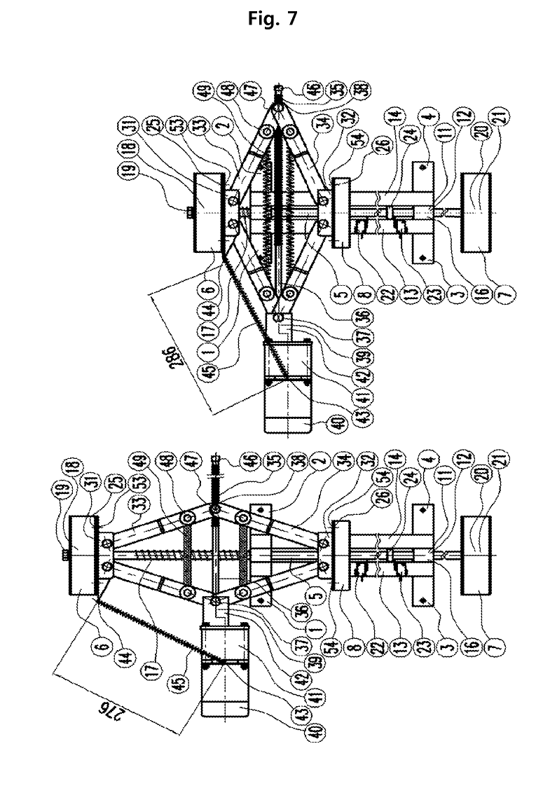

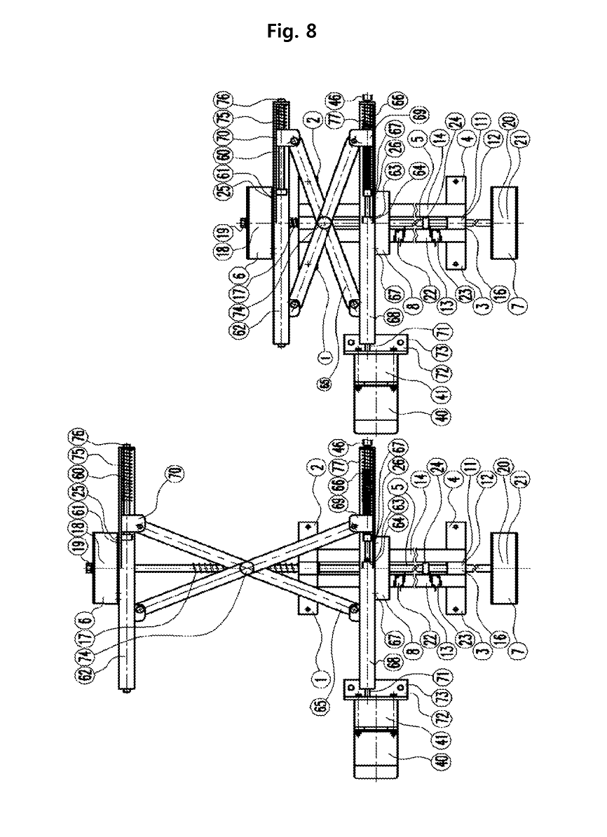

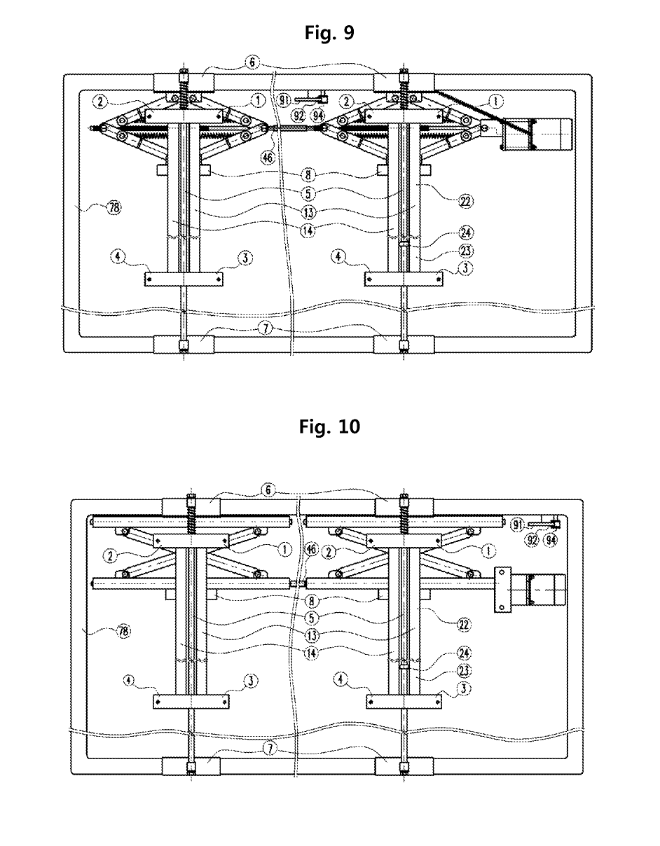

FIG. 7 and FIG. 8 show a front view of complete moving up/down of driving parts, FIG. 9 and FIG. 10 expresses a rear view more easily than the front view as ascent/descent device be installed on board, and also installation of blackboard frame (78) and unit/safety device (91,92,94) and necessity can be easily understood.

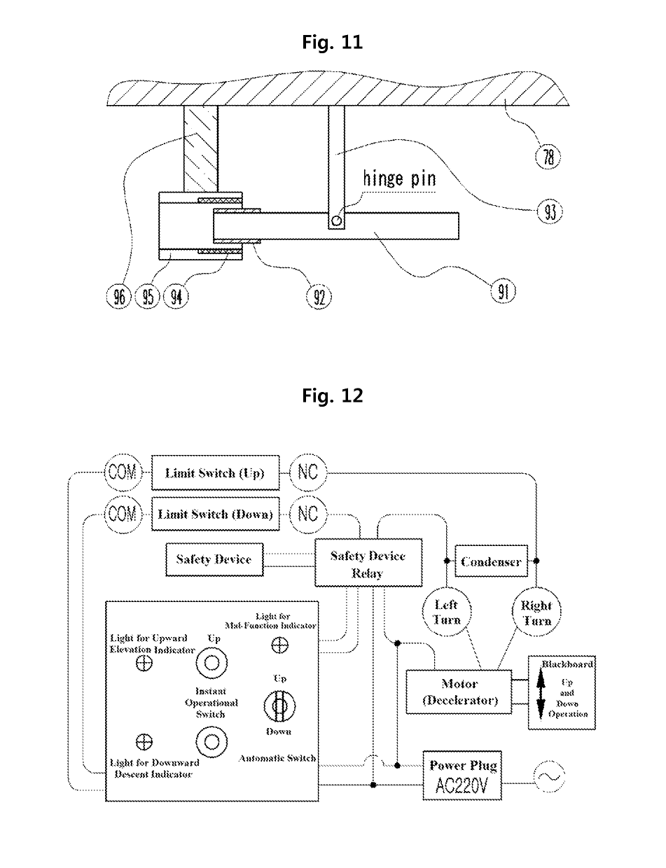

In FIG. 11 shows parallel connection of this product in case that board is too big and heavy with safety device by the application of balance principle. Wide width of board causes it stop if moving upward has problem. But, it should be stopped by safety device considering board can be skewed by obstacle or breakdown, etc if having some problem because the risk in moving downward is much bigger than moving upward for the reason of self-gravity of board. Weight support bar (93) is connected to weight (93) by hinge. Both electrode fixed bar (96) without flexure are fixed upper inside of blackboard frame (78), and in other part weight balance (91) and connector (95) are fixed and connected to safety device relay conforming electrode A (92) and electrode B (94). Weight support bar (93) and weight balance (91) keep horizontal commonly. To avoid malfunction for vibration or oscillation, weight balance (91) needs to be heavy. Electrode A (92) and electrode B (94) are not connected in case of front/rear/left/right oscillation, and need to be connected to only up/down move according to declension of board. At this point, electrode of connector (95) and weight balance (91) is made only upper and lower part, and weight balance (91) shut off electric flow of lower end limit switch (23) since safety device relay operates by connection of electrode A and B. Finally, upper end limit switch (22) circuit is alive and cause can be removed by moving board upward.

FIG. 12 is a panel operation figure and wiring of board up/down device, and upper/lower end limit switch (22,23) and stop ring (24) are used for automatic control of blackboard frame (78). Otherwise, one line of single phase AC220V in utilization box and power supply terminal is connected to motor (40) and other two lines are to terminal box for motor (40), condensor, manual toggle, push button switch, relay, and lamp. In terminal box, same wire to motor is only to turn on operation lamp. In toggle and push button switch, each common terminal COM is connected to upper/lower end limit switch (22,23), and upper/lower end limit switch (22,23) is installed on left stay (13). NC terminal is used for upper/lower end limit switch (22,23) commonly, and left/right rotational wire of motor should be connected to condensor making C-phase. Stop Ring (24) is installed in slider bar up and down (5), and upper/lower end limit switch (22,23) is operated on the upper/lower part at maximum. If operating switch, motor is energized since upper/lower end limit switch (22,23) is NC commonly. Motor is rotated in the direction of left or right by supply of C-phase from condenser. blackboard frame (78) moves up/down and stops if stop ring (24) hits upper/lower end limit switch (22,23) and electricity breaks. Inverting operation switch operates upper/lower end limit switch (22,23) in contrary, and then upper/lower end limit switch (22,23) releasing and again keeping NC status. If electricity is supplied in anytime, it starts operating. If user wants to operate for the first time after stopping operation, he should repeat above process. While blackboard frame (78) is moved up/downward by toggle and push button switch as much as it is necessary, it stops at the place by releasing push button and neutralizing toggle. It stops automatically at the max. height range by upper/lower end limit switch (22,23). It operates by upper/lower end limit switch (22,23) if pressing, and stops if releasing.

FIG. 13 shows a configuration of rubber pad (97) by safety device to be installed between wall surface space and blackboard frame (78). The gap between wall and upper blackboard frame is used as capacities of frames of flags, lesson, etc, but side and bottom of blackboard frame (78) has risk of hand damage. For this reason, rubber and silicon material rubber pad (97) is installed on wall side of blackboard frame (78) to prevent safety accident in advance in case of moving up/down. The shape of rubber pad (97) can resist force enough, and the side of board is thick and the side of wall is thin to prevent noise even if it touches wall surface.

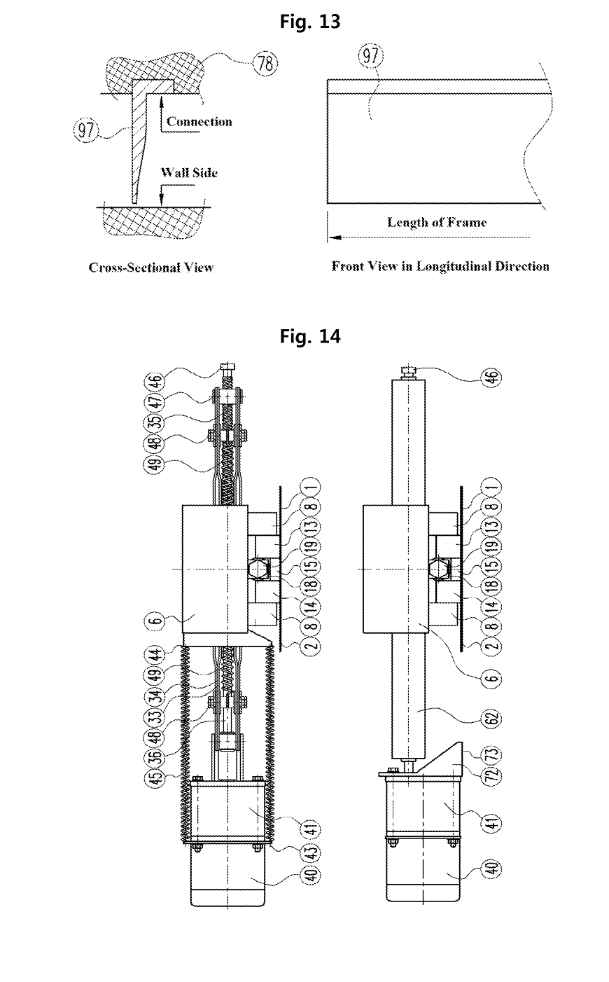

FIG. 14 shows floor plan, and the link of two kind of driving device, 4-bar link and 2-section scissor, utilization of anchor support (1,2,3,4) can be understood. 4-bar is expressed by think line since mark of link structure is complicated.

The core of this invention is summarized as three points. First, for convenience of field installation and simplicity, all components, except two kind of main driving part, 4-bar link or 2-section scissor, are assembled and completed as base unit. The simple connection of driving part in this unit is connected to unit lower end fixed hole (26) and 4-bar linkage lower end fixed hole (54) or 2-section lower fixture hole with bolt and to unit upper end fixed hole (25) by 4-bar linkage upper end fixed hole (53) or 2-bar x-join upper end fixed hole (61). Secondly, like the principle of leverage, strong vertical force, that is, large operating range can be obtained just by small horizontal force. whole floating weight of blackboard frame according to up/down move is supported to link arm and therefore very small reduced weight is delivered to driving part, that is link arm operating screw, making structure which causes small noise and putting forth stable and great power kinematically. Thirdly, moving downward can be operated by small power according to self-gravity of board. The unbalance, between the power of descent, assisted by self-gravity of blackboard, and ascent, can be solved as the power of ascent/descent becomes almost equal by assistance of tensility and elasticity of compression spring by installing 4-bar link to tension spring (49) and bar put in compression spring (17) to 2-section scissor.

### INDUSTRIAL APPLICABILITY

Board auto up/down move device of this invention is used for national and public institutions and private institutions such as school, academy, private education, etc, and technology of board up/down move device can be used variously in the field of industry which produces blackboard or board plate.

What is claimed is:

1. A blackboard device that can move a blackboard frame (78) in an up or down direction comprising:
at least two multiple link arms (33, 34, 65);
at least one hinge connecting said multiple link arms;
a right screw axis which moves at least above said one link arm in an up or down direction, said right screw axis connected to at least one of said link arms; and
a motor (40) which is attached above said right screw axis.

2. The blackboard device of claim 1 further including:
a slide bar up and down (5) on said link arm (33,34);
a slide device (9,10,11,12) which enables said slide bar up and down (5) possible to move in an up or down direction;
a support upper/lower end link arm (31,32) linked to said upper and lower part of above link arm (33,34),
and up/down link fitting (6,7) fixed on the both end of slider bar up and down (5),
and installing above right screw axis (35) on the center of said link arm (33,34), above support upper/lower end link arm (31,32) is composed to move up/downward vertically according to the operation of above right screw axis (35) and above link arm (33,34).

3. The blackboard device of claim 2, wherein:
said link arms (33,34) are composed of four 4-bar link arms, anchor support (1,2,3,4) is installed between said board upper/lower fixtures (6,7), and said support upper end link arm (31) can be linked to blackboard upper end fixing part (6).

4. The blackboard device of claim 3, further including:
a motor part (40,41,42,43) composed of centerrotate spindle (36) which is connected to said right screw axis (35),
a motor (40), gear speed reduction (41), and
a motor combine plate (42), wherein said motor combine plate (42) at the end of centerrotate spindle (36) connected with bushing (37) part by welding, motor part (40,41,42,43) and centerrotate spindle (36) being on a line and cantilever of bushing (37) by establishing motor part (40,41,42,43)'s enough strength, therefore installation gap becoming small between wall surface and blackboard frame (78) and rubber pad (97) being installed in above gap, connecting motor tension spring (45) to motor part (40,41,42,43) and blackboard upper end fixing part (6) can make supplement bad effect due to cantilever construction by equipping blackboard upper end fixing part (6) with blackboard spring hook (44).

5. The blackboard device of claim 4, wherein:
said tension spring hook (48) is installed on link arm (3,34) and equipping tension spring (49), washer (52) being inserted at both end of link arm (33,34) installation surface by tightening bolt (50) and nut (51),
power can be reinforced by making clamping groove for tension spring (49) at 3 places of center, left, and right side and equipping 2˜6 tension springs (49) according to strength of tension spring (49) and weight.

6. The blackboard device of claim 5, where:
said link arm (33,34) can be mechanically stabilized by being assembled as wide bottom and narrow top in the longitudinal right/left direction.

7. The blackboard device of claim 1, wherein:
said link arm (65) is composed of two 2-bar x-join arm (65), including upper/lower end support fixture (62,68) linked to link arm (65) with hinge; and slider bar upper end (60) which slides being accepted to lower end support fixture (68), it composes to move up/downward upper support (62) if left and right spin screw (66) is accepted to lower end support fixture (68) and rotated by motor.

8. The blackboard device of claim 7, wherein:
said lower end support fixture (68) is fixed to support fixture operating (8) by bolt, upper support (62) moving up/down by operation of link arm (65) due to motor part (40,41,72) and left and right spin screw (66), board upper/lower link fixture (6,7) fixed at the end of slider bar up and down (5), anchor support (1,2,3,4) installed between board upper/lower link fixture (6,7) and fixed on wall, and upper support (62) linked to blackboard upper end fixing part (6) by bolt and board upper/lower link fixture (6,7) connected to blackboard frame (78), blackboard frame (78) can be moved up/down by motor (40).

9. The blackboard device of claim 4 or 8, further including:
a weight support bar (93),
a weight balance (91),
an electrode fixed bar (96),
an access tunnel (95),
an electrode A (92), and
an electrode B (94) being equipped on internal upper surface, above blackboard frame (78) can be stopped by electrode A (92) and electrode B (94) contacted due to slide of blackboard frame (78) and relay operating.

10. The blackboard device of claim 8, further including:
an upper/lower end compression spring (75,77) connected to left and right spin screw (66) and slider bar upper end (60), such that power can be supplemented by compressed spring tension caused by moving upward from the lowest end of internal both ends of upper/lower end support fixture (62,68).

11. An upward or downward blackboard device comprising:
a blackboard frame (78) that is moveable in an up or down direction;
at least two link arms (33,34,65) coupled together with a hinge;
left and right spin screw (35,66) which move at least above one link arm in up/down direction, connected to at least one link arm of above multiple link arms (33,34,65); and
a motor (40) which drives above an axis of said right screw.
